(19) United States
(12) Patent Application Publication
(10) Pub. No.: US 2015/0040707 A1
(43) Pub. Date: Feb. 12, 2015

(54) REDUCER FOR VEHICLE

(71) Applicant: MANDO CORPORATION, Pyeongtaek-si (KR)

(72) Inventor: Kwang Seok HONG, Seoul (KR)

(21) Appl. No.: 14/306,978

(22) Filed: Jun. 17, 2014

(30) Foreign Application Priority Data
Aug. 6, 2013 (KR) 10-2013-0093042

(51) Int. Cl. H02K 7/116; F16H 1/16

(52) U.S. Cl. CPC H02K 7/1166; F16H 1/16
USPC 74/425

(57) ABSTRACT

Disclosed is a reducer of a vehicle. Size and weight of the reducer can be reduced by removing a pivot bearing and a damping coupler which are expensive and used for supporting a movement of a worm shaft and for buffering an impact applied to the worm shaft in a conventional reducer, thereby saving a manufacturing cost.

### CROSS-REFERENCE TO RELATED APPLICATION

This application claims the priority under 35 U.S.C. §119(a) to Korean Patent Application Serial No. 10-2013-0093042, which was filed in the Korean Intellectual Property Office on Aug. 6, 2013, the entire content of which is hereby incorporated by reference.

### BACKGROUND OF THE INVENTION

1. Field of the Invention

The present invention relates to a reducer of a vehicle, and more particularly, to a reducer of a vehicle in which its size and weight can be reduced by removing a pivot bearing and a damping coupler which are expensive and used for supporting a movement of a worm shaft and for buffering an impact applied to the worm shaft in a conventional reducer, thereby saving a manufacturing cost.

2. Description of the Related Art

FIG. 1 is a sectional view illustrating a reducer of a vehicle according to a conventional art.

As shown in FIG. 1, the reducer 100 of the vehicle according to the conventional art includes a worm shaft 103 on which a worm 101 is formed, worm shaft bearings 105a and 105b mounted on both ends of the worm shaft 103 respectively to support the worm shaft 103, a plug bolt 107 disposed between a damping coupler 109 and a worm shaft bearing 257 in order to prevent the worm shaft bearings 105 from being spaced in an axial direction of the worm shaft 103, and a plug nut 111 for fixing the plug bolt 107.

The worm shaft 103 is connected to a shaft 115 of the electric motor by means of the damping coupler 109, which is rotated by a driving of the electric motor 113.

The worm wheel 117 is disposed on a side of an outer periphery of the worm 101 and is tooth-engaged with the worm 101 formed on the worm shaft 103. The worm wheel 117 is mounted on the steering shaft 119 which transmits a rotation force of the steering wheel 102 operated by the driver, and transmits the rotation force of the worm shaft 103 generated by the electric motor 113 to the steering shaft 119.

A gear housing 121 has the worm shaft 103, the worm wheel 117 and the like disposed therein. The electric motor 113 is mounted on a side of the gear housing 121 to provide a driving force to the worm shaft 103, and a motor cover 123 combined with the electric motor 113 is coupled with the gear housing 121 by means of a bolt 125.

The worm shaft bearing 105b has a structure in which balls 131 are interposed between an inner race 127 and an outer race 129, and supports a rotation of the worm shaft 103 connected to the electric motor shaft 115 of the electric motor 113.

On the other hand, a pivot bearing is provided as the worm shaft bearing 105b, which supports a coupling portion of the motor shaft 115, among the worm shaft bearings 105a and 105b supporting the worm shaft 103, and support a movement of the worm shaft 103.

However, as the reducer of the vehicle according to the conventional art is provided with the pivot bearing, the damping coupler, and the like, which are expensive and support the movement of the worm shaft in order to buffer the impact, there is a problem in that a whole size and a manufacturing cost of the reducer increase.

### SUMMARY OF THE INVENTION

The present invention has been developed to solve the above-mentioned problem in the conventional art, and an aspect of the present invention is to provide a reducer of a vehicle in which its size and weight can be reduced by removing a pivot bearing and a damping coupler which are expensive and used for supporting a movement of a worm shaft and for buffering an impact applied to the worm shaft in a conventional reducer, thereby saving a manufacturing cost.

The aspect of the present invention is not limited thereto, and other aspects of the present invention will be apparently understood by those skilled in the art through the below description.

In accordance with an aspect of the present invention, a reducer of a vehicle is provided. The reducer includes: a motor housing in which a rotation supporting member is movably coupled to a coupling hole and supported by the motor housing, the rotation supporting member supporting one end, which is connected to a worm shaft, of both ends of a motor shaft coupled to the worm shaft which is tooth-engaged with a worm wheel; a gear housing which encloses the worm wheel and the worm shaft and is coupled to the motor housing; an elastic member interposed between an outer peripheral surface of the rotation supporting member and an inner peripheral surface of the coupling hole; an elastic supporting body which is disposed in the coupling hole and buffers an axial movement of the rotation supporting member; and a stopper member which is disposed in the coupling hole so as to prevent a separation of the elastic supporting body.

According to the embodiment of the present invention, size and weight of the reducer can be reduced by removing a pivot bearing and a damping coupler which are expensive and used for supporting a movement of a worm shaft and for buffering an impact applied to the worm shaft in a conventional reducer, thereby saving a manufacturing cost.

### BRIEF DESCRIPTION OF DRAWINGS

The above and other aspects, features, and advantages of the present invention will be more apparent from the following detailed description taken in conjunction with the accompanying drawings, in which:

FIG. 1 is a sectional view illustrating a reducer of a vehicle according to a conventional art;

FIG. 2 is a sectional view illustrating a reducer of a vehicle according to an embodiment of the present invention;

FIGS. 3 and 4 are an exploded perspective view partially illustrating a worm gear of FIG. 2;

FIG. 5 is a view illustrating a gap between a rotation supporting member and a coupling hole of FIG. 2;

FIG. 6 is a sectional view illustrating a reducer of a vehicle according to another embodiment of the present invention; and

FIG. 7 is a sectional view illustrating a reducer of a vehicle according to still another embodiment of the present invention.

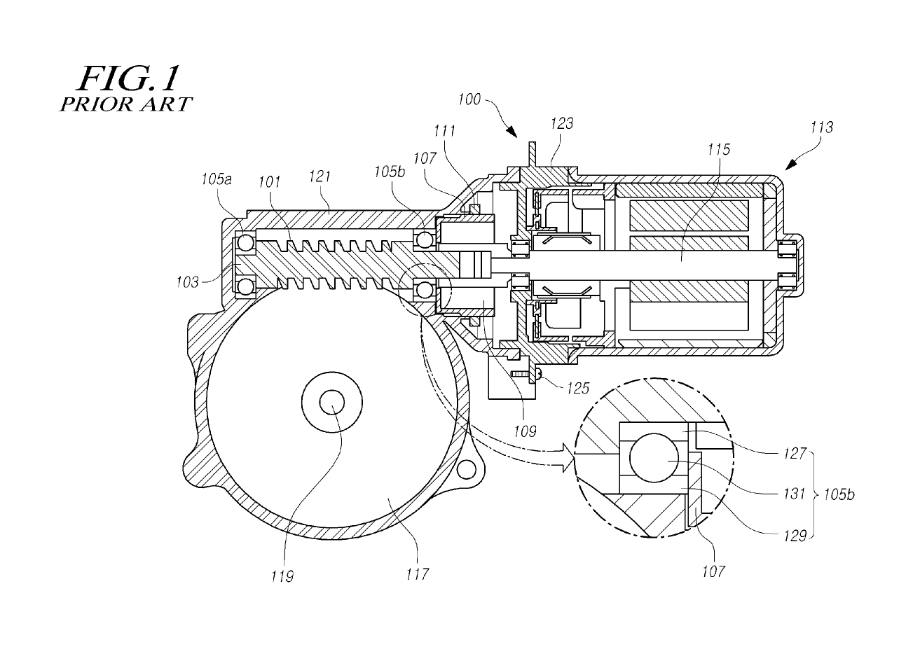

### DETAILED DESCRIPTION OF THE EXEMPLARY EMBODIMENTS

Hereinafter, exemplary embodiments of the present invention will be described with reference to the accompanying drawings. In the description of the elements of the present invention, terms “first”, “second”, “A”, “B”, “(a)”, “(b)” and the like may be used. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

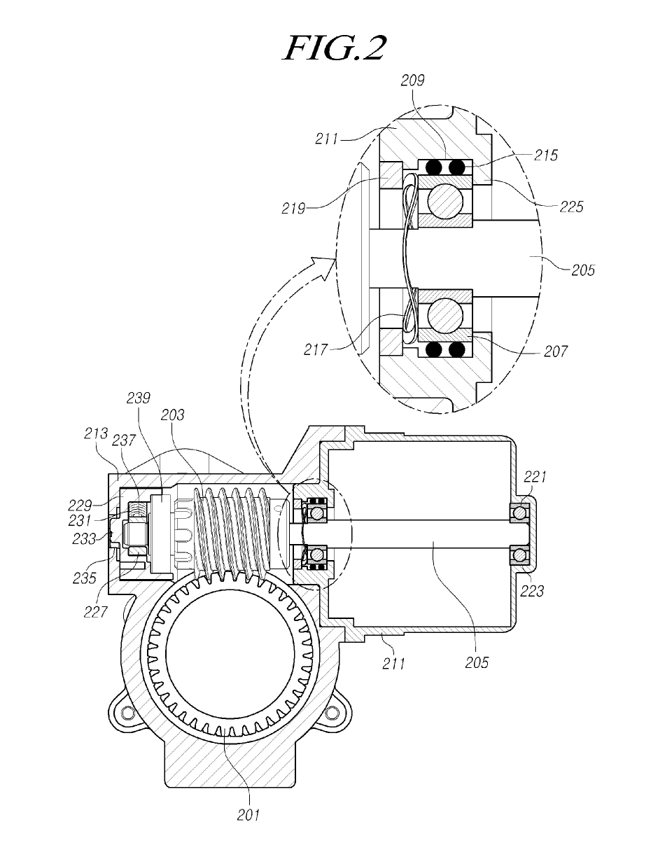

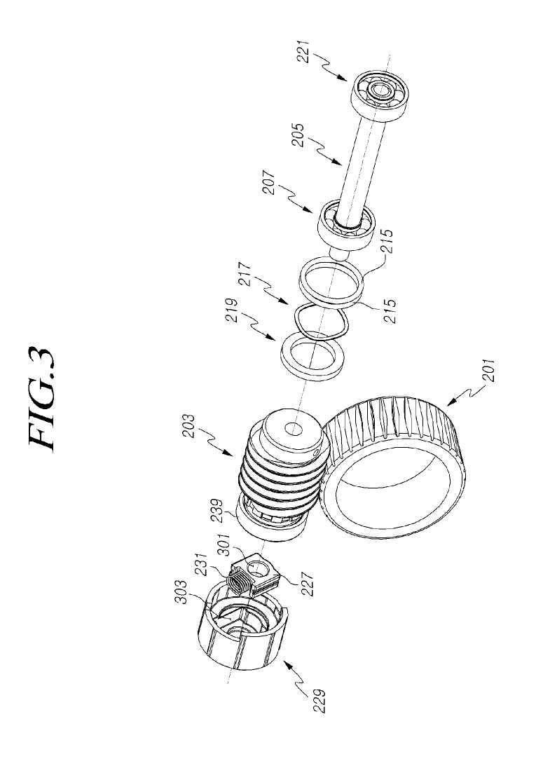

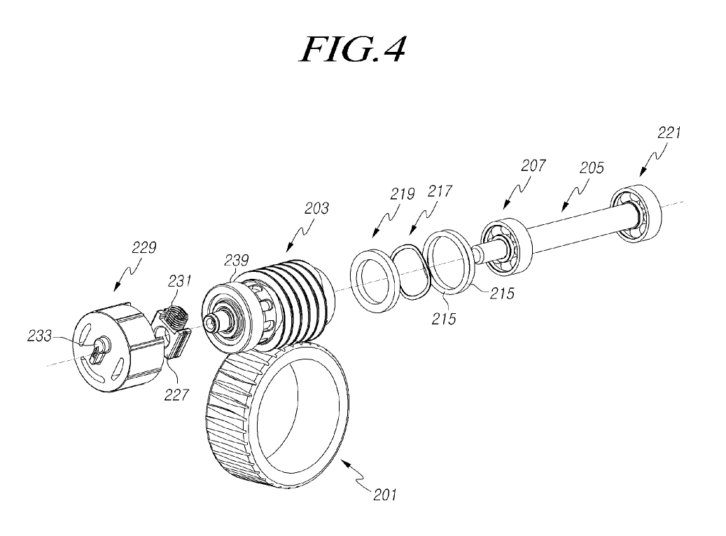

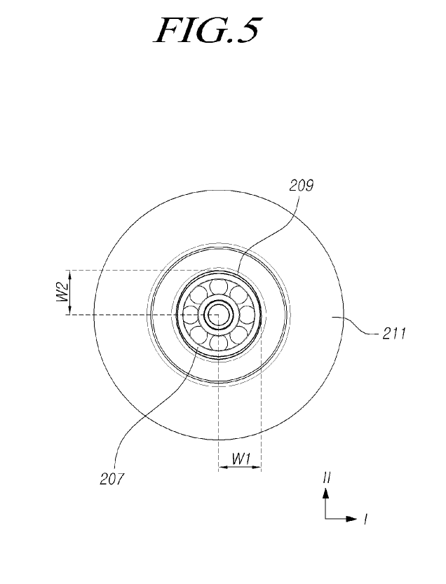

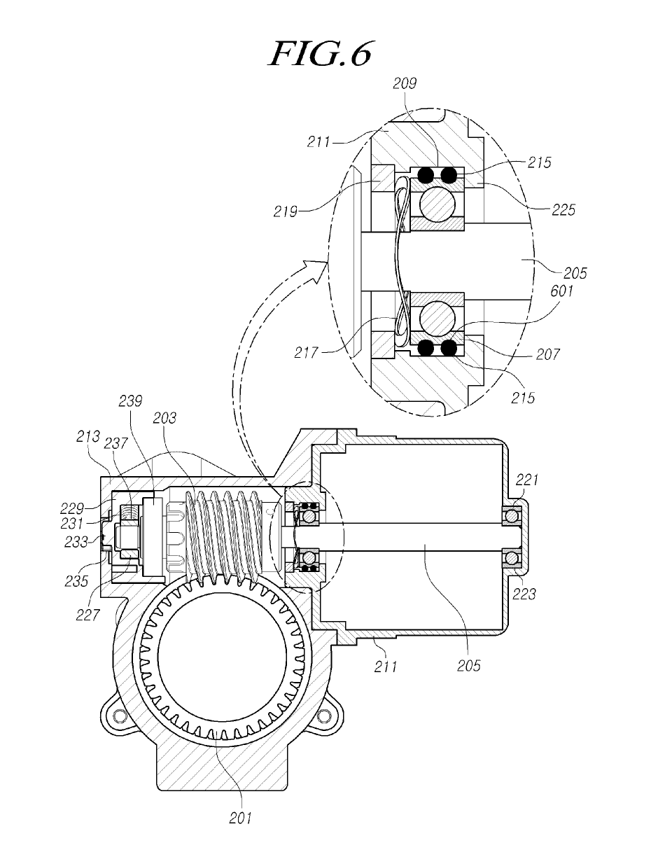

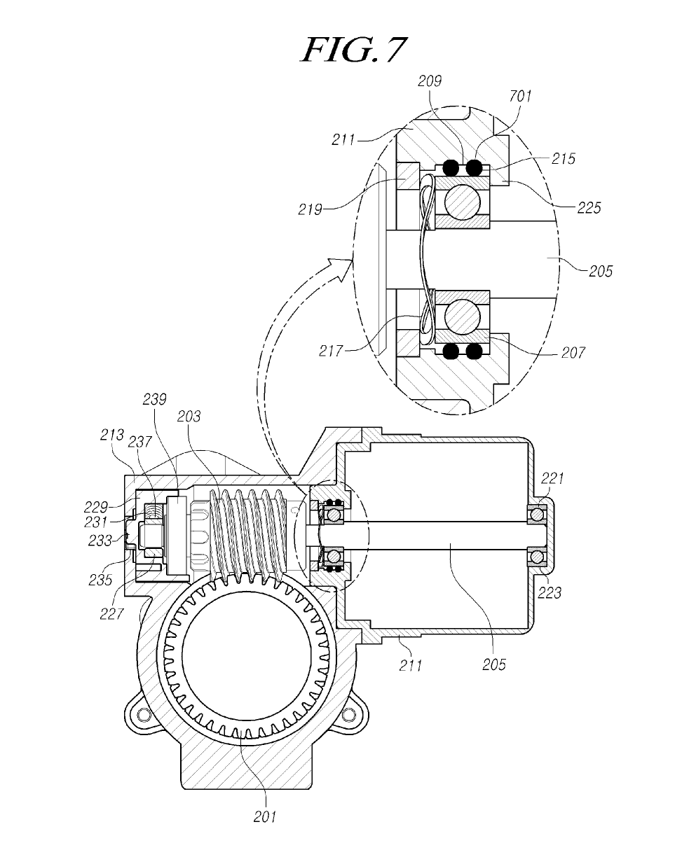

FIG. 2 is a sectional view illustrating a reducer of a vehicle according to an embodiment of the present invention. FIGS. 3 and 4 are an exploded perspective view partially illustrating a worm gear of FIG. 2. FIG. 5 is a view illustrating a gap between a rotation supporting member and a coupling hole of FIG. 2. FIG. 6 is a sectional view illustrating a reducer of a vehicle according to another embodiment of the present invention. FIG. 7 is a sectional view illustrating a reducer of a vehicle according to still another embodiment of the present invention.

As shown in the drawings, the reducer of the vehicle according to the embodiment of the present invention includes: a motor housing 211 in which a rotation supporting member 207, which supports one, i.e., one end connected to the worm shaft, of both ends of a motor shaft 205 coupled with the worm shaft 203 tooth-engaged with the worm wheel 201, is movably disposed in a coupling hole 209 and supported by the motor housing 211; a gear housing 213 which encloses a worm wheel 201 and a worm shaft 203, and is connected to the motor housing 211; an elastic member 215 interposed between an outer peripheral surface of the rotation supporting member 207 and an inner peripheral surface of the coupling hole 209; an elastic supporting body 217 which is disposed in the coupling hole 209 and buffers an axial movement of the rotation supporting member 207; and a stopper member 219 coupled to the coupling hole 209 so as to prevent a separation of the elastic supporting body 217.

The motor housing 211 has the motor shaft 205 therein. The motor shaft 205 is coupled to the worm shaft 203, and the worm shaft 203 is tooth-engaged with the worm wheel 201.

On the other hand, the rotation supporting members 207 and 221 are mounted on both ends of the motor shaft 205 respectively, in which the rotation supporting member 207 supporting one end of the motor shaft 205 connected to the worm shaft is movably coupled to the coupling hole 209 formed in the motor housing 211 and supported by the motor housing 211, and the rotation supporting member 221 supporting the other end of the motor shaft 205 distal from the worm shaft is inserted in the supporting groove 223 and the supported by the motor housing 211.

Here, the rotation supporting member 207 supporting the one end of the motor shaft 205 connected to the worm shaft is, for example, a ball bearing, which is movably coupled to the coupling hole 209. The coupling hole 209, as shown in FIG. 5, has a width W1 of a first direction I, and a width W2 of a second direction II perpendicular to the first direction I, which are different. For example, the coupling hole 209 has an oval shape in which the first direction I indicates a short axis, and the second direction II indicates a long axis.

Further, the second direction II of the above-mentioned coupling hole 209 is set to a direction corresponding to a direction in which an elastic supporting force of the elastic body 231 is applied to elastically support a holder 227 described later in a direction toward a worm wheel.

On the other hand, in FIG. 5, an elastic member 215 mounted on an outer peripheral surface of the rotation supporting member 207 is not described, for convenience of an expression.

As described above, since the rotation supporting member 207 is movably coupled to the coupling hole 209, it is possible to remove a conventional pivot bearing which is expensive and used to movably support the worm shaft, thereby saving a cost of manufacturing products.

Further, a protruding step portion 225 is formed on an inner peripheral surface of the coupling hole 209 of the motor housing 211. The protruding step hole 209 radially protrudes toward the worm shaft of the coupling hole 209, and axially supports the rotation supporting member 207.

Accordingly, the gear housing 213 encloses the worm wheel 201 and the worm shaft 203, and is coupled to the motor housing 211.

The elastic member 215 is interposed between an outer peripheral surface of the rotation supporting member 207 and the inner peripheral surface of the coupling hole 209, and prevents the outer peripheral surface of the rotation supporting member 207 from bumping the inner peripheral surface of the coupling hole 209. The elastic member 215 includes an annular ring made of an elastic material and is coupled to be in close contact with the outer peripheral surface of the rotation supporting member 207.

On the other hand, as shown in FIG. 6, a seating groove 601 may be further formed on the outer peripheral surface of the rotation supporting member 207 in order to support the elastic member 215. By forming the seating groove 601 on the outer peripheral surface of the rotation supporting member 207, the elastic member 215 may be disposed on the outer peripheral surface of the rotation supporting member 207.

Of course, as shown in FIG. 7, a supporting groove 701 may be formed along a circumference of the coupling hole 209 on the inner peripheral surface of the coupling hole 209 so as to support the elastic member 215.

Moreover, the elastic supporting body 217 is provided within the coupling hole 209 and buffers an axial movement of the rotation supporting member 207. For example, the elastic supporting body 217 has a hollow shape, and a structure in which convex portions and concave portions alternate so as to form waves along the circumference of the coupling hole 209.

Since the elastic supporting body 217 is provided within the coupling hole 209, the elastic supporting body 217 buffers the axial movement of the rotation supporting member 207 even though the motor shaft 205 moves in an axial direction as the worm shaft 203 and the worm wheel 201 are tooth-engaged with each other.

Further, the stopper member 219 is coupled to the coupling hole 209 to prevent the separation of the elastic supporting body 217, and has an annular shape in the center thereof, through which the motor shaft 205 extends.

On the other hand, the stopper member 219 is press-fitted into the coupling hole 209. Threads are formed on the outer peripheral surface of the stopper member 219, and also on a part of the inner peripheral surface of the coupling hole 209, so that the stopper member 219 is screwed with the coupling hole 209.

As described above, by coupling the stopper member 219 to the coupling hole 209, it is possible to prevent the elastic supporting body 217, which elastically supports the rotation supporting member 207 in the axial direction, from being separated from the coupling hole 209 to an outside.

In addition, the reducer according to the embodiment of the present invention further includes: a holder 227 which has a block shape at the center of which a coupling hole 301 is formed in order to receive one end of the worm shaft 203 distal from the motor shaft 205; a holder cap 229 which is coupled to an inner end of the gear housing 213 and has a blind hole in which a holder groove 303 is formed and the holder 227 is press-fitted into the holder groove 303; and an elastic body 231 which is interposed between the holder 227 and the inner peripheral surface of the holder cap 229 in a direction opposite to the worm wheel and elastically supports the holder 227, to which one end of the worm shaft 203 is coupled, in a direction to the worm wheel 201.

The holder 227 is provided in a block shape, at the center of which the coupling hole 301 is formed. The one end of the worm shaft 203 opposite to the other end connected to the motor shaft 205 is inserted in and coupled to the coupling hole 301 of the holder 227.

The holder cap 229 is provided in the form of the blind hole, in which the holder groove 303 into which the holder 227 is press-fitted is formed on an inner surface of the holder cap 229. The holder cap 229 is coupled to the inner end of the gear housing 213, and a protruding supporting portion 233 is further formed axially on an outer peripheral surface of the holder cap 229.

Further, the rotation supporting member 239, which rotatively supports one end of the worm shaft 203 opposite to a coupling portion of the motor shaft 205, is inserted in the holder cap 229, so as to support the outer peripheral surface of the rotation supporting member 239 on the inner peripheral surface of the holder cap 229.

On the other hand, the protruding supporting portion 233 formed on the holder cap 229 is inserted into an insertion hole 235 formed in the gear housing 213. As the insertion hole 235 is formed in the gear housing 213 as described above, a coupling position can be easily set when the holder cap 229 is coupled to the gear housing 213.

The elastic body 231 is interposed between the holder 227 and the inner peripheral surface of the holder cap 229 opposite to the worm wheel 201, and elastically supports the holder 227, to which the one end of the worm shaft 203 is coupled, in a direction to the worm wheel 201. The elastic body 231 may be provided, for example, in the form of a coil spring.

Further, the elastic body 231 is coupled to a protrusion 237 protruding on the outer peripheral surface of the holder 227 opposite to the worm wheel 201, of which the elastic supporting force is stably transferred to the holder 227.

As described above, since the reducer according to the embodiment of the present invention is provided with the holder 227, the holder cap 229, the elastic body 231, and the like, it is possible to compensate for a gap caused by abrasion of teeth between the worm shaft 203 and the worm wheel 201. Thereby, the steering feel and a steering response can be improved, and a generation of noise can be prevented.

According to the embodiment of the present invention, size and weight of the reducer can be reduced by removing a pivot bearing and a damping coupler which are expensive and used for supporting a movement of a worm shaft and for buffering an impact applied to the worm shaft in a conventional reducer, thereby saving a manufacturing cost.

Even if it was described above that all of the components of an embodiment of the present invention are coupled as a single unit or coupled to be operated as a single unit, the present invention is not necessarily limited to such an embodiment. At least two elements of all structural elements may be selectively joined and operate without departing from the scope of the present invention. Although the embodiments of the present invention have been described for illustrative purposes, those skilled in the art will appreciate that various modifications, additions and substitutions are possible, without departing from the scope and spirit of the invention. The scope of the present invention shall be construed on the basis of the accompanying claims in such a manner that all of the technical ideas included within the scope equivalent to the claims belong to the present invention.

### DESCRIPTION OF REFERENCE NUMERALS

201: worm wheel
203: worm shaft
205: motor shaft
207: rotation supporting member
209: coupling hole
211: motor housing
213: gear housing
215: elastic member
217: elastic supporting body
219: stopper member

What is claimed is:

1. A reducer for a vehicle, comprising:
a motor housing in which a rotation supporting member is movably coupled to a coupling hole and supported by the motor housing, the rotation supporting member supporting one end, which is connected to a worm shaft, of both ends of a motor shaft coupled to the worm shaft which is tooth-engaged with a worm wheel;
a gear housing which encloses the worm wheel and the worm shaft and is coupled to the motor housing;
an elastic member interposed between an outer peripheral surface of the rotation supporting member and an inner peripheral surface of the coupling hole;
an elastic supporting body which is disposed in the coupling hole and buffers an axial movement of the rotation supporting member; and
a stopper member which is disposed in the coupling hole so as to prevent a separation of the elastic supporting body.

2. The reducer as claimed in claim 1, wherein a protruding step portion radially protrudes on the inner peripheral surface of the coupling hole toward the worm shaft and axially supports the rotation supporting member.

3. The reducer as claimed in claim 2, wherein the elastic member has an annular shape, and is coupled to be in close contact with an outer peripheral surface of the rotation supporting member.

4. The reducer as claimed in claim 3, wherein the elastic supporting body has convex portions and concave portions alternating to form waves along a circumference.

5. The reducer as claimed in claim 1, wherein a seating groove is further formed along a circumference on the outer peripheral surface of the rotation supporting member, so as to support the elastic member.

6. The reducer as claimed in claim 1, wherein a supporting groove is further formed along a circumference on the inner peripheral surface of the coupling hole, so as to support the elastic member.

7. The reducer as claimed in claim 1, further comprising:
a holder which has a block shape in which a coupling hole is formed at a center thereof and coupled to one end of the worm shaft opposite to the other end thereof connected to a motor shaft;
a holder cap which is coupled to an inner end of the gear housing and has a blind-hollow shape formed with a holder groove, in which the holder is press-fitted, on an inner surface thereof, and in which a bearing rotatively supporting the one end of the worm shaft opposite to the other end of the worm shaft connected to the motor shaft is inserted; and
an elastic body which is interposed between the holder and the inner peripheral surface of the holder cap opposite to the worm wheel and elastically supports the holder, to which the end of the worm shaft is coupled, toward the worm wheel.

8. The reducer as claimed in claim 7, wherein a protruding supporting portion is further formed on the outer peripheral surface of the holder cap, and an insertion hole is further formed in the gear housing, in which the protruding supporting portion is inserted.
